(19) United States
(12) Patent Application Publication
(10) Pub. No.: US 2003/0143514 A1
(43) Pub. Date: Jul. 31, 2003

(54) Dental implant comprising means for preventing rotation of of the superstructures

(76) Inventor: Guy Gabriel Peltier, Rueil-Malmaison (FR)

Correspondence Address: LARSON & TAYLOR, PLC, 1199 NORTH FAIRFAX STREET, SUITE 900, ALEXANDRIA, VA, 22314, US

(21) Appl. No.: 09/522,591

(22) Filed: Mar. 10, 2000

(30) Foreign Application Priority Data
Mar. 12, 1999 (FR) 99 03 054

(51) Int. Cl. A61C 8/00

(52) U.S. Cl. 433/173; 433/172

(57) ABSTRACT

Screw-in dental implant comprising an implant body (made of titanium, zirconium or ceramic) intended to be implanted in the mandible bone or in the maxilla bone: a so-called post or abutment piece (2) (made of titanium, zirconium or ceramic) which is to take the tooth, which can be fixed upright or pre-inclined by 5°, in steps of 5°, to as much as 20°, by a transfixing screw (3). The post is centered and prevented from rotating with respect to the implant body by 24 to 36 teeth made on each face of the implant and of the post (2), these teeth being clamped down one set onto the other by a transfixing screw (3). Each face of each piece has 24 to 36 teeth (4) with an angle in cross section from 45° to 90° maximum.

The present invention relates to an improvement in dental implants and, in particular, to an implant which to a sufficient extent prevents the rotation of the superstructures, such as a post or abutment, on the implant body proper.

A dental implant usually comprises an implant body, preferably externally threaded and internally tapped, intended to be implanted in the bony tissue of the mandible or of the maxilla, and a post or abutment piece which can be transfixed onto the implant body, so that it stands up above the implant body in order to be able to take a dental prosthesis. For the prosthesis to be appropriately oriented with good parallelism with respect to the natural teeth, it is necessary that the practitioner should be able to orientate the post or abutment piece about the axis of the implant body before fixing it. The same is true of the inclination, which can be obtained either by a variable-inclination means, or using a set of pre-inclined posts. To allow angular adjustment in terms of rotation about the axis of the implant body, it is known practice to use indexing means such as a polygonal assembly, for example one with 6 faces. These known indexing means create local reductions in thickness which are detrimental to the robustness of the implant, given the very high loadings to which it may be subjected. Furthermore, the number of angular positions is small. If the number of angular positions is to be increased, the dimensions of the facets decrease, which lowers the resistance to rotation, given the very high loadings that the implant may be subjected to, and angular misalignments are often observed in patients.

The present invention sets out to overcome these drawbacks and to provide a dental implant which is particularly well able to withstand all loadings, including those in rotation, while at the same time being simple, very easy to fit, and providing a great many angular positions.

The subject of the invention is a dental implant comprising an implant body (1), preferably externally threaded and internally tapped, and a post or abutment piece (2) (2a) which can be transfixed onto the implant, the implant body have an upper face against which a lower face of the post or abutment presses, characterized in that said faces have a high number of mutually-complementing radial teeth.

The number of such teeth is preferably from 18 or 24 to 36 teeth.

Thus, when the post or abutment is mounted on the implant body, immobilization in terms of rotation in the desired angular position is obtain and so at the same time is perfect centering of the two pieces, which can then very easily be permanently secured together by a locking means such as a transfixing screw (3).

A side from the perfect centering and the prevention of rotation, excellent anti-wobble and anti-slip are also achieved, with a complete absence of play.

These teeth (4) (4a) are preferably of triangular cross section and preferably form an angle in cross section of 45° to 90°. They are preferably open onto the outside diameter of the implant (1) and of the post or abutment (2) (2a).

When the teeth are cut into the aforementioned faces, it must be understood that the width of material available increases from the inside of the implant radially toward its external periphery. It is preferable that the teeth be cut in such a way that each of the two faces which are intended to be in mutual contact has only sharp tooth crests and sharp troughs without any flat regions. This then leads to the use of a milling cutter of triangular cross section which moves in order to machine the teeth, in a radial plane of the implant, but in a direction which is inclined slightly with respect to the plane perpendicular to the axis of the implant.

For example, if the two faces of the implant body and of the post are initially flat, and therefore perpendicular to the common axis of the implant, the sets of teeth of one of the two pieces will preferably be cut in such a way that the bottom of the tooth is inclined in the radial plane, preferably by 8° to 12°, the depth of the tooth increasing toward the periphery, and the tops preferably remaining in the initial plane of the face, while the other piece will be cut in such a way that the bottom of the set of teeth is not inclined, the tops then being inclined, with the cut, in a way that complements the bottom of the teeth in the first piece.

In another example, the bottoms of the teeth are inclined, on each piece, by 4° to 6°, the passages of the cutter then being oriented at an angle for each piece.

The post or abutment (2) (2a) may be upright or pre-inclined by 5°, in steps of 5°, to as much as 20° which, with a choice from a set of posts, makes it possible to obtain 5 angular inclinations with respect to the axis of the implant.

Other advantages and features of the invention will become apparent from reading the following description which is given by way of non-limiting example and with reference to the appended drawing, in which:

FIG. 1 depicts a view with axial section of the upright post or abutment (2) with the transfixing screw (3) according to the invention, in a first embodiment.

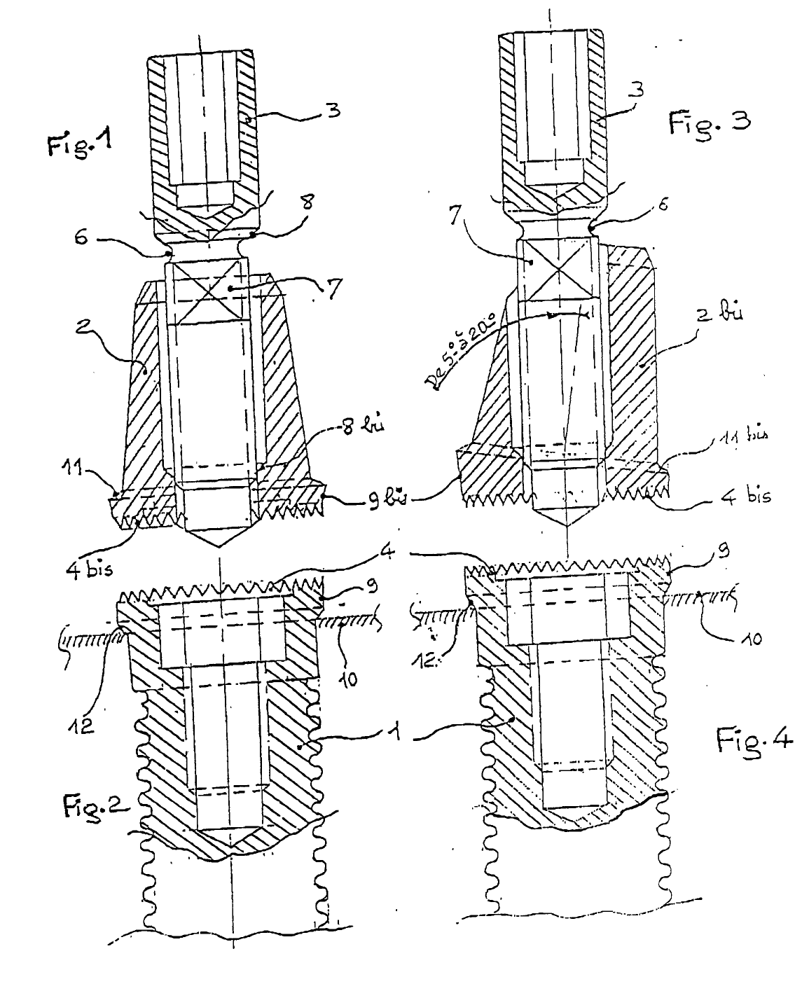

FIG. 2 depicts a view of the implant (1) in axial section, with its supra-osseous part (9) ending with its face which has the 24 to 36 cut teeth (4) from 45° to 90° maximum, for preventing rotation.

FIG. 3 depicts a view with axial section of a pre-inclined post or abutment (2a), with its face which has the 24 to 36 cut teeth (4a) from 45° to 90° maximum, to prevent rotation; this face fitting together perfectly with the similar face of the implant (1) once the teeth (5) have been nested together.

FIG. 4 depicts a view with axial section of the implant (1) according to the invention, showing the supra-osseous part (9) measuring 0.5 to 1 mm, which may correspond to a single surgical stage.

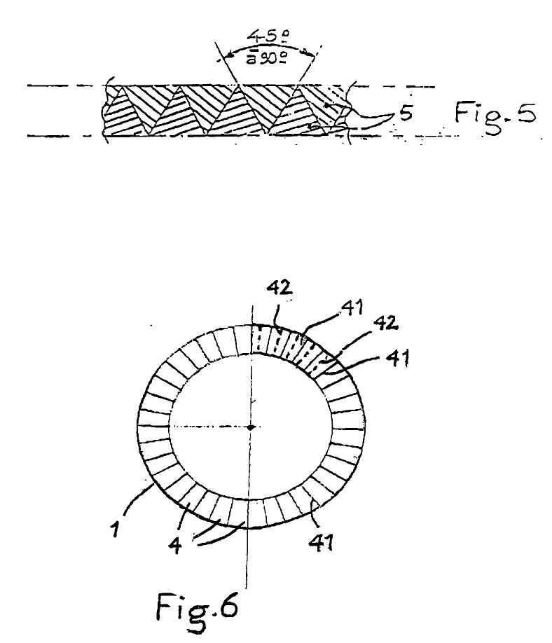

FIG. 5 depicts a view in part section of the two cut parts (5)—face of the implant (1) and face of the post (2)—nested together perfectly, given that 24 to 36 teeth (4) (4a) have been identically cut on a diameter of the implant (1) equal to the diameter of the post (2).

FIG. 6 depicts a view from above of the set of teeth (4) of the implant body.

FIGS. 1 and 3 depict the transfixing screw (3) and, on the one hand, show the rounded-bottom safety groove (6) which can act as a break point, possibly, and juxtaposed with the polygon (7), preferably square, intended to allow the threaded part of the screw (3) which has remained inside the implant (1) to be unscrewed. The part separating the two diameters of the screw (3) will be flat or conical (8) at a 90° angle, ensuring the widest possible contact area in the post.

The screw-in dental implant (1) is made of titanium, zirconium or ceramic, the so-called post or abutment piece (2) (2a) being intended to take a dental prosthesis surmounted with a tooth made of ceramic or resin.

Referring more especially to FIGS. 5 and 6, it can be seen that, in the example depicted, the upper face of the implant body (1) has 36 teeth. Solid line has been used in FIG. 6 to show the crests formed by the tops 41 of the teeth (4) and, for some teeth, broken line has been used to show the troughs 42 of the triangular teeth (4). Starting with a flat face located in a plane perpendicular to the axis of the body of the implant, a cutter of triangular section, appropriately sharpened with the desired tooth angle (this angle preferably being between 45° and 90°) for cutting the triangular teeth is used for cutting the teeth.

To make sure that the tops of the teeth form sharp edged crests 41, the cutter which moves radially with respect to the axis of revolution of the implant body moves in its radial plane in an inclined direction, for example inclined by 8° to 12°, so that the depth of the teeth increases from the central part toward the peripheral surface of the implant (1). The set of teeth of the corresponding face of the post (2) is, of course, made in a more or less corresponding way so that the teeth of the two pieces nest together appropriately over the maximum possible area.

Of course, if the faces are already conical, with a slight cone angle, instead of being flat, the person skilled in the art will make the appropriate adaptations to the inclination of the path of the cutter used to machine the teeth in its radial plane.

The invention may be further improved in a number of ways.

The dental implant (1) screwed into the bone (10) emerges slightly by 0.5 to 1 mm with a diameter slightly greater than the nominal threaded diameter of the implant (1), which provides a good seal against the bone (10) because of the small conical part (12) which connects the two diameters of the implant (1).

The post (2) or the abutment (2a) have a part, which nests together with the implant (1), of a varying height of 0.3 to 3 mm, or even 4, adapted to the thickness of the gum. To the rear of this variable-height part is a conical face (11) which is to support the prosthesis which takes the tooth.

According to the improved connection between the implant (1) and the post or abutment (2) (2a), that is to say the locking by the 24 to 36 cut teeth (4) (4a) of 45° to 90° maximum, an angular adjustment of 10° to 15° per tooth is obtained, relative to the development with respect to the 360° of circumference. This 10° to 15° accuracy makes it possible, with the 4 or 5 possible inclinations of the post or abutment (2) (2a) when it is inclined as in FIG. 3, to obtain an implant position very similar to that of the natural teeth.

Unlike the known polygonal rotation-preventing systems which have a maximum of 12 angular positions and always have some functional play, on a circumscribed diameter of 3.20 mm, for a hexagon measuring 2.70 mm across flats, whereas if one considers that a fixing screw with a diameter of about 2.00 mm reduces the cross section providing the implant or post with resistance to rotation or constant bending strength, the invention makes it possible to increase this resistance and robustness by transmitting the loadings onto a maximum diameter, namely the outside diameter of the implant which, in the case of a single molar or premolar, has itself to be as large as possible, while remaining within an overall mean, namely a diameter of 4.5 to 6 mm, eliminating any play.

According to one improvement of the present invention, the robustness of the assembly is ensured by the fixing, following immobilization of the screw (3), which, before fitting, will have had a little dental cement (of the thread-locking type) deposited around the plain part of this screw (3) or even also around the threaded part screwed into the implant (1).

This screw (3) has a number of particular features, the main one of which is that: in the event of breakage, the presence of a safety groove (6) which is supposed to act as a break point, precisely locating the site of any breakage, means that once the screw (3) has broken, it will be easy to remove the threaded part which has remained in the implant (1), by virtue of the presence of a square part (7) provided for this purpose and juxtaposed with the groove (6).

The practitioner will make use of a special key supplied with the toolkit.

1. Dental implant comprising an implant body (1) intend to be implanted in the bony tissue of the mandible or of the maxilla, a so-called post or abutment piece (2) (2a) which is to take a dental prosthesis, the assembly of the two pieces—implant (1) and post (2) (2a)—being intended to be secured by a transfixing screw (3), said two pieces being pressed on to the other via two faces, characterized in that these two faces have a great many complementary radial teeth.

2. Implant according to claim 1, characterized in that said teeth are open to the exterior surface of the two pieces (1) (2) (2a).

3. Implant according to one of claims 1 and 2, characterized in that it has 24 to 36 teeth.

4. Implant according to one of claims 1 to 3, characterized in that the cross sections of the teeth exhibit angles of 45° to 90°.

5. Implant according to one of claims 1 to 4, characterized in that the post or abutment (2a) forms part of a set of posts or abutments preinclined at 5°, 10°, 15° and 20°.

6. Implant according to one of claims 1 to 5, characterized in that said radial teeth (4) have only acute crests and troughs (41, 42) on said faces.

7. The implant according to one of claims 1 to 6, characterized in that the teeth (4) of at least one of the pieces are cut with inclined cutting passages.

8. Implant according to claim 7, characterized in that the inclination is between 8° and 12° for one of the pieces (1, 2 or 2a) or between 4° and 6° for each piece.

9. Implant according to one of claims 1 to 8, characterized in that the fixing screw (3) is of the type intended to be locked with dental cement.

10. Implant according to one of claims 1 to 9, characterized in that the screw (3) has a safety groove (6) which acts as a break point, so as to allow the threaded part of the screw remaining in the implant to be unscrewed using a key collaborating with part (7) of the screw in the vicinity of the groove (6).
